(19) United States
(12) Patent Application Publication
(10) Pub. No.: US 2026/0368178 A1
(43) Pub. Date: Nov. 19, 2026

(54) GENERATIVE ARTIFICIAL INTELLIGENCE-BASED INFORMATION PROVISION DEVICE, INFORMATION PROVISION SYSTEM INCLUDING SAME, AND INFORMATION PROVISION METHOD

(71) Applicant: LS ELECTRIC CO., LTD., Anyang-si, Gyeonggi-do (KR)

(72) Inventors: Min Ji JO, Anyang-si, Gyeonggi-do (KR); Sang Wook SOHN, Anyang-si, Gyeonggi-do (KR)

(21) Appl. No.: 19/515,529

(22) PCT Filed: Aug. 22, 2024
(86) PCT No.: PCT/KR2024/012556

§ 371 Date: Mar. 2, 2026

(30) Foreign Application Priority Data
Dec. 20, 2023 (KR) 10-2023-0186903

(51) Int. Cl. G06F 16/2455; G06F 16/248

(52) U.S. Cl. CPC G06F 16/24553; G06F 16/248

(57) ABSTRACT

A generative artificial intelligence-based information provision system according to an embodiment of the present disclosure comprises: a user database for storing a collection request item for each user; a source database for storing source information collected on the basis of the collection request item; and an information provision device for retrieving source information including a variable keyword from pieces of source information collected in the source database on the basis of a pre-provided prompt, inputting the prompt and the retrieved source information to a generative artificial intelligence model to acquire result information corresponding to the prompt, and transmitting the result information corresponding to the collection request item to a user terminal.

### CROSS-REFERENCE TO RELATED APPLICATION

This application is the national phase entry of International Application No. PCT/KR2024/012556, filed on Aug. 22, 2024, which is based upon and claims priority to Korean Patent Application No. 10-2023-0186903, filed on Dec. 20, 2023, the entire contents of which are incorporated herein by reference.

### FIELD

The present disclosure relates to a generative artificial intelligence-based information provision device, an information provision system including the same and an information provision method.

### BACKGROUND

Generative artificial intelligence (GAI) is one type of artificial intelligence technology that generates or creates new data based on given input data. Since the generative AI model generates new data based on its understanding of training data, it can be used in various fields, such as document writing, art creation, voice synthesis, game character creation and engineering design. However, the generative AI model has a problem that it cannot guarantee the accuracy and usefulness of the generated content because it shows the so-called hallucination phenomenon, which provides incorrect information about unlearned content.

In order to solve this, a new architecture called retrieval-augmented generation (RAG) was developed that improves the performance of text generation by integrating the large language model (LLM) of a generative AI model and an information search model.

Meanwhile, smart factories have become a hot topic recently due to the development of related technologies such as the Internet of Things (IOT) and artificial intelligence (AI). Smart factories are a general term for manufacturing systems that operate by applying information and communications technology (ICT) combined with digital automation solutions in the production process such as design, development and manufacturing.

One of the key requirements in running a smart factory is to understand information that is closely related to the product or company and has high importance and practicality.

For example, when an issue occurs, such as the discontinuation of equipment parts in the field, the bankruptcy of an equipment manufacturer or the release of new equipment, it is important to respond quickly and appropriately to the issue by ensuring that the information level between the equipment manager and the support department manager is aligned, and preventing the omission of key information.

To this end, it is necessary to establish a plan to build an information provision system utilizing the RAG architecture such that relevant parties, including smart factory operation managers and production planners, can supply or receive necessary information at an appropriate time.

### SUMMARY

An object of the present disclosure is to provide a generative artificial intelligence-based information provision device that provides information that is closely related to a target product or company and has high importance and practicality, an information provision system including the same and an information provision method.

An object of the present disclosure is to provide a generative artificial intelligence-based information provision device that automatically provides information for trend identification, an information provision system including the same and an information provision method.

The generative artificial intelligence-based information provision system according to an embodiment of the present disclosure may include: a user database configured to store a collection request item for each user; a source database configured to store source information collected based on the collection request item; and an information provision device configured to search source information including a variable keyword among source information collected in the source database based on a pre-provided prompt, input the prompt and the searched source information to a generative artificial intelligence model to acquire result information corresponding to the prompt, and transmit result information corresponding to the collection request item to a user terminal.

The information provision device may transmit alarm information together when the result information includes a caution keyword.

The information provision device may receive the collection request item including at least one of a product type, a product manufacturer and a product model name, and store the collection request item and user information corresponding to the collection request item to construct the user database.

The information provision device may collect the source information based on the collection request item through a web server, store the source information, and construct the source database.

The information provision device may construct a vector database by vector-embedding the source information.

The information provision device may generate the result information based on a similarity between an embedding vector of the prompt and an embedding vector in the vector database by using a generative artificial intelligence model.

The generative artificial intelligence-based information provision device according to an embodiment of the present disclosure may include: a processor configured to search source information including a variable keyword among source information collected according to a collection request item for each user based on a pre-provided prompt, input the prompt and the searched source information to a generative artificial intelligence model to acquire result information corresponding to the prompt, and transmit result information corresponding to the collection request item to a user terminal.

The generative artificial intelligence-based information provision method performed by an information provision device according to an embodiment of the present disclosure may include: searching source information including a variable keyword among source information collected according to a collection request item for each user based on a pre-provided prompt; inputting the prompt and the searched source information to a generative artificial intelligence model to acquire result information corresponding to the prompt; and transmitting result information corresponding to the collection request item to a user terminal.

According to one embodiment of the present disclosure, by continuously receiving information on a desired field, the omission of important information can be prevented, and it is possible to quickly respond when an issue occurs.

According to one embodiment of the present disclosure, by automating the provision of highly reliable and accurate information, resources required for identifying industry trends can be minimized, and it can support to enable efficient production.

According to one embodiment of the present disclosure, it is possible to prevent unexpected costs by appropriately responding to issues through information level matching between a business site equipment manager and a support department manager.

An information processing system according to one embodiment of the present disclosure can significantly reduce the amount of data processing compared to when it is implemented in the form of a chatbot, thereby providing economically feasible, accurate and reliable information and enabling stable service provision.

According to one embodiment of the present disclosure, an independent database for a smart factory can be constructed to provide information that is closely related to a target product or company and has high importance and practicality.

### BRIEF DESCRIPTION OF THE DRAWINGS

FIG. 1 is a schematic diagram illustrating an information provision system according to one embodiment of the present disclosure.

FIG. 2 is a block diagram illustrating the configuration of an information provision device according to one embodiment of the present disclosure.

FIG. 3 is a diagram illustrating the operation flow diagram of an information provision device according to one embodiment of the present disclosure.

FIG. 4 is a diagram illustrating the operation of an information provision system according to one embodiment of the present disclosure.

FIG. 5 is a drawing illustrating the result information generation appearance of an information provision device according to one embodiment of the present disclosure.

FIG. 6 is a drawing illustrating the operation of an information provision device according to one embodiment of the present disclosure.

### DETAILED DESCRIPTION

Hereinafter, preferred embodiments of the present disclosure will be described in detail with reference to the accompanying drawings. The detailed description to be disclosed below together with the accompanying drawings is intended to describe exemplary embodiments of the present disclosure, and is not intended to represent the only embodiments in which the present disclosure may be practiced. In the drawings, in order to clearly describe the present disclosure, parts that are not related to the description may be omitted, and the same reference numerals may be used for the same or similar components throughout the specification.

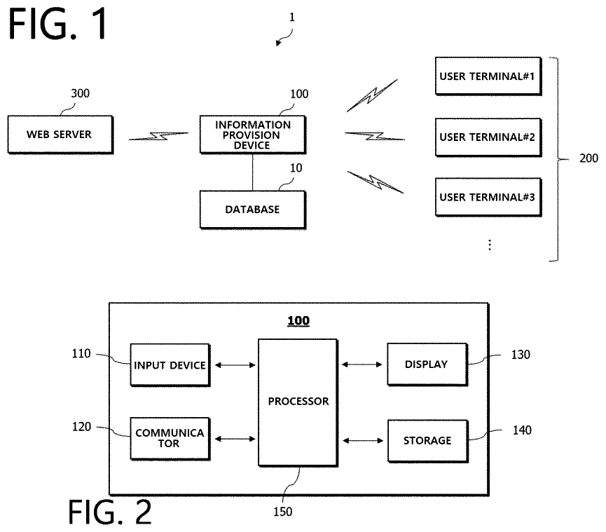

FIG. 1 is a schematic diagram illustrating an information provision system according to one embodiment of the present disclosure.

An information provision system 1 (hereinafter, referred to as a system 1) according to one embodiment of the present disclosure may include a database 10, an information provision device 100, a user terminal 200 and a web server 300.

The database 10 is a device that stores information required in the process of the information provision device 100 providing information. The database 10 may be implemented by dividing into two or more databases as needed, and the implementation method is not limited to any one of being implemented as a separate device from the information provision device 100 or being implemented within the information provision device 100.

The information provision device 100 is a device that provides information required in the operation process of a smart factory, and may be implemented as a computer, server, smart phone, tablet PC, smart pad, laptop or the like. In this case, the information provision device 100 may provide not only information, but also provide notification information that notifies of major changes, such as the release or update of a product or technology, the bankruptcy of a manufacturer, the discontinuation of a product/part or the like.

The user terminal 200 is a device that receives information provided from the information provision device 100, and may be implemented as a computer, a PLC (Programmable Logic Controller), a server, a smart phone, a tablet PC, a smart pad, a laptop or the like. In this case, the user terminal 200 may be a terminal of a person in charge of a smart factory, a smart factory server or equipment within a smart factory. The user terminal 200 may be a device that has a manufacturing execution system (MES), an employee assistance program (EAP), a recipe parameter management system (RPMS) and the like built therein.

The web server 300 is a source for collecting information required by the information provision device 100, and the information provision device 100 may collect information from the web server 300 by performing crawling.

In the present disclosure, an information provision system 1 utilizing the RAG architecture is proposed such that relevant parties, including smart factory operation managers and production planners, can supply or receive necessary information at an appropriate time.

Hereinafter, the configuration and operation of an information provision device 100 according to one embodiment of the present disclosure will be specifically described with reference to the drawings.

FIG. 2 is a block diagram illustrating the configuration of an information provision device according to one embodiment of the present disclosure.

An information provision device 100 according to one embodiment of the present disclosure may include an input device 110, a communicator 120, a display 130, a storage 140 and a processor 150.

The input device 110 generates input data in response to a user input of the information provision device 100. For example, the user input may be a user input that initiates the operation of the information provision device 100, a user input that sets a collection request item, a user input that sets a variable keyword or a caution keyword, a user input that inputs a prompt, a user input for collecting source information, a user input required for constructing a database and the like. In addition, if it is a user input required for transmitting result information corresponding to a collection request item to a user terminal, it may be applied without limitation.

The input device 110 includes at least one input means. The input device 110 may include a keyboard, a key pad, a dome switch, a touch panel, a touch key, a mouse, a menu button or the like.

The communicator 120 may perform communication with external devices such as a user terminal 200 and a web server 300 to transmit and receive collection request items, user information, source information, result information and the like.

To this end, the communicator 120 may perform wireless communication such as 5G (5th generation communication), LTE-A (Long Term Evolution-Advanced), LTE (Long Term Evolution), Wi-Fi (Wireless Fidelity) and Bluetooth, or wired communication such as LAN (Local Area Network), WAN (Wide Area Network) and power line communication.

The display 130 displays display data according to the operation of the information provision device 100. The display 130 may display a screen that displays collection request items and user information, a screen that displays source information, a screen that displays result information, a screen that receives a user input and the like.

The display 130 includes a liquid crystal display (LCD), a light emitting diode (LED) display, an organic light emitting diode (OLED) display, a micro electro mechanical systems (MEMS) display and an electronic paper display. The display 130 may be implemented as a touch screen by being combined with the input device 110.

The storage 140 stores the operation programs of the information provision device 100. The storage 140 includes a non-volatile storage that is capable of preserving data (information) regardless of whether power is supplied, and a volatile memory into which data to be processed by the processor 150 is loaded and which cannot preserve data if power is not supplied. The storage includes a flash memory, a hard disk drive (HDD), a solid-state drive (SSD), a read only memory (ROM) and the like, and the memory includes a buffer, a random access memory (RAM) and the like.

The storage 140 may be implemented by including any one of the databases 10 as described above. The storage 140 may store collection request items, user information, source information, result information, generative artificial intelligence models and the like, and may store computational programs and the like that are required in the process of performing source information collection and search, vector embedding, generative artificial intelligence model operation, result information acquisition and the like.

The processor 150 may control at least one other component (e.g., a hardware or software component) of the information provision device 100 by executing software such as a program, and may perform various data processing or operations.

The processor 150 according to one embodiment of the present disclosure searches for source information including a variable keyword among source information collected according to a collection request item for each user based on a pre-provided prompt, inputs the prompt and the searched source information to a generative artificial intelligence model to acquire result information corresponding to the prompt, and transmits the result information corresponding to the collection request item to a user terminal.

In this case, the processor 150 may construct a database and/or a generative artificial intelligence model, or may receive and store a previously constructed database and/or a generative artificial intelligence model from the outside and use the same, but is not limited to any one.

Meanwhile, the processor 150 may perform at least some of the data analysis, processing and result information generation for performing the above operations by using at least one of a machine learning, neural network or deep learning algorithm as a rule-based or artificial intelligence algorithm. Examples of the neural network may include models such as a convolutional neural network (CNN), a deep neural network (DNN), a recurrent neural network (RNN) and a transformer.

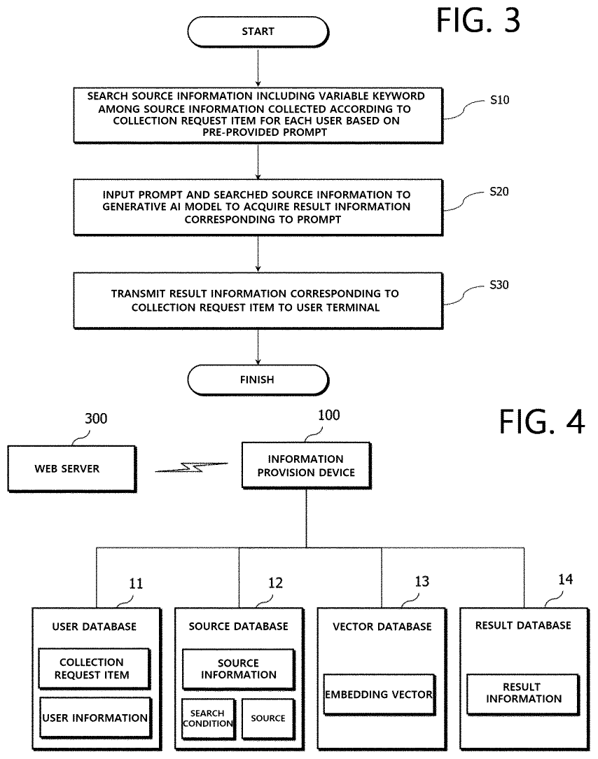

FIG. 3 is a diagram illustrating the operation flow diagram of an information provision device according to one embodiment of the present disclosure.

The processor 150 according to one embodiment of the present disclosure may search for source information including a variable keyword among source information collected according to a collection request item for each user based on a pre-provided prompt S10.

Collection request items are items for which the user wishes to receive information and alarms, and may include at least one of a product type, a product manufacturer and a product model name. In addition, collection request items may include collection period, information provision cycle and the like.

The processor 150 may receive a collection request item from the user terminal 200, and for example, the processor 150 may receive a collection request item requesting information about a circuit breaker and circuit breaker manufacturers, Company A and Company B, once every two weeks.

In this case, collection request items may be set not only for individual users but also for groups such as teams and departments, and if collection request items are set for groups, the same information and alarms may be provided for the same group.

The processor 150 may receive a collection request item from the user terminal 200 and collect source information based on the collection request item through a web server 300.

Source information refers to raw data that is related to the collection request items, and for example, source information may be original news articles about Company A, which is a circuit breaker manufacturer, or research articles on circuit breaker technology.

The processor 150 may collect source information by searching for circuit breakers, Company A and Company B, for example, in a search portal, or may collect source information within the corporate sites of Company A and Company B.

In this case, the processor 150 may collect source information by using a separate program that performs crawling and scraping. Specifically, the processor 150 may load an HTML page, parse HTML/CSS and the like, and extract necessary source information. Alternatively, the processor 150 may call an Open API to a service that provides an Open API (Rest API) to extract necessary source information, and additionally, any technology that collects source information may be applied without limitation.

Meanwhile, as described above, the present disclosure adopts the RAG architecture to improve the performance of text generation of a generative artificial intelligence model, and the RAG architecture largely consists of a generative artificial intelligence model and a vector database.

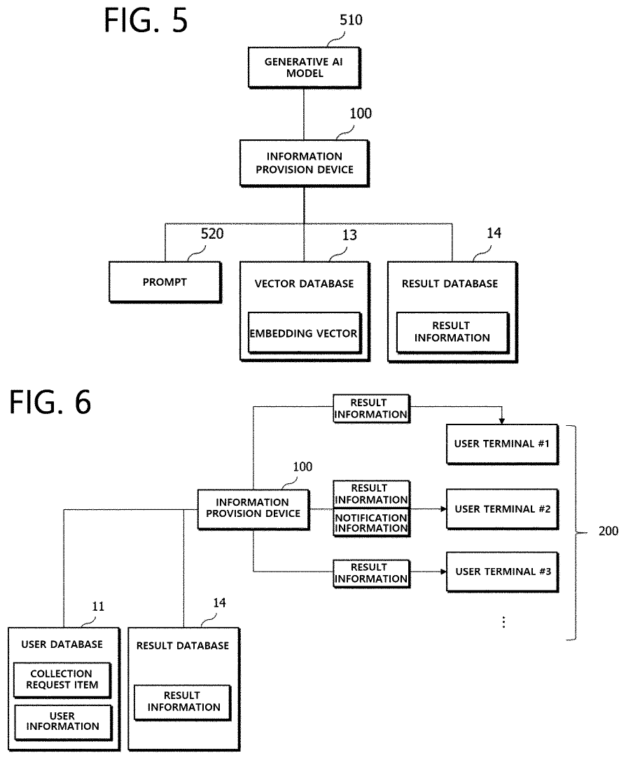

The generative AI model may be a giant language model, and the vector database is constructed by vector-embedding information that is referenced in providing answers corresponding to queries from the giant language model. In this case, the reference information may be collected source information or information searched based on a prompt from the collected source information. This will be specifically described with reference to FIG. 5.

A prompt is a query that is input to a generative artificial intelligence model, and may be set up to periodically generate information to be provided to user terminals, and may be pre-provided to properly reflect the purpose of providing information according to the collection request items for each user.

The processor 150 may search for source information including a variable keyword among source information collected based on a pre-provided prompt.

For example, if the prompt is “Please summarize in three sentences news articles about circuit breaker manufacturer A that include a variable keyword and provide up to five core keywords including the variable keyword”, the processor 150 may search for news information about circuit breaker manufacturer A that includes a variable keyword (update, new, launch, bankruptcy, discontinuation, etc.) among the collected source information. The processor 150 may receive a user input for setting a variable keyword or receive information about a variable keyword from the user terminal 200.

The processor 150 according to one embodiment of the present disclosure may input a prompt and searched source information to a generative artificial intelligence model to acquire result information corresponding to the prompt S20.

The processor 150 may store the searched source information by vector-embedding the same in a vector database. The processor 150 may generate result information based on a similarity between an embedding vector of the prompt and an embedding vector in the vector database. The similarity may be determined by a distance measurement method such as Euclidean distance or cosine similarity, and the similarity may also be measured in various other known ways. The processor 150 may generate result information by using the embedding vectors with the highest similarity through a generative artificial intelligence model. In this case, the processor 150 may acquire result information by forming an enhanced prompt including both pf the embedding vector of the prompt and the embedding vector in the vector database and inputting the enhanced prompt into the generative artificial intelligence model.

The processor 150 according to one embodiment of the present disclosure may transmit result information corresponding to a collection request item to a user terminal S30.

The result information may include information requested through a prompt, a summary of the information requested or information indicating key changes.

The processor 150 may transmit alarm information together with the result information when the result information includes a caution keyword. The caution keyword refers to a keyword that requires special caution, such as bankruptcy or discontinuation. Similarly, the processor 150 may receive a user input for setting a caution keyword, or may receive information about a caution keyword from the user terminal 200. The alarm information may be transmitted by being included in the result information, or may be transmitted separately from the result information in the form of a pop-up window, and may be transmitted with a voice or warning sound in addition to text, and the alarm form is not limited to any one.

According to one embodiment of the present disclosure, by continuously receiving information on a desired field, the omission of important information may be prevented, and it is possible to quickly respond when an issue occurs.

According to one embodiment of the present disclosure, by automating the provision of highly reliable and accurate information, resources required for identifying industry trends may be minimized, and it may support to enable efficient production.

According to one embodiment of the present disclosure, it is possible to prevent unexpected costs by appropriately responding to issues through information level matching between a business site equipment manager and a support department manager.

FIG. 4 is a diagram illustrating the operation of an information provision system according to one embodiment of the present disclosure.

FIG. 4 specifically explains the collection request items and source information collection process during the operation process of the information provision device 100 described above with reference to FIG. 3. In this regard, the description of any content that overlaps with the content described with reference to FIG. 3 will be omitted.

As described above, the database 10 of FIG. 1 may be implemented with two or more databases as needed. The database may include a user database 11, a source database 12, a vector database 13 and a result database 14.

In this case, each database may be implemented separately, but two or more databases may be combined and implemented as needed. For example, the user database 11, the source database 12 and the result database 14 may be implemented as one database.

According to one embodiment of the present disclosure, the processor 150 may construct a user database 11 by storing collection request items and user information corresponding to the collection request items. The user information may include account information and affiliation information of a user who will receive information and alarms. The user's account information may include a mail account, a team channel address and the like. As described above, when the collection request items are set in groups, the processor 150 may transmit the same result information to multiple user accounts having the same affiliation information.

When the processor 150 receives an updated collection request item from the user terminal 200, it may modify the collection request item in the user database 11 and record the change history. In this case, a separate log database that records the change history may be provided.

The processor 150 may collect source information based on collection request items through a web server 300, and store the source information to construct a source database 12.

The source database 12 may store source information, search conditions and the source of the source information together. In this case, the search conditions may be the same as the collection request items, or may be separately processed conditions to reflect the collection request items. The source of the source information may be a uniform resource location (URL) of the source information, and the processor 150 may record a source of the source information in various ways in addition to the URL.

The processor 150 may construct a vector database 13 by vector-embedding source information, and may construct a result database 14 by storing result information generated for each prompt.

The information processing system 1 according to one embodiment of the present disclosure may significantly reduce the amount of data processing compared to when it is implemented in the form of a chatbot, thereby providing economically feasible, accurate and reliable information and enabling stable service provision.

According to one embodiment of the present disclosure, an independent database for a smart factory may be constructed to provide information that is closely related to a target product or company and has high importance and practicality.

FIG. 5 is a drawing illustrating the result information generation appearance of an information provision device according to one embodiment of the present disclosure.

The information provision device 100 may perform source information re-search-importance evaluation-final selection based on a generative artificial intelligence model 510, in order to select the source information that is most suitable for the collection request item among the collected source information.

First of all, the information provision device 100 may search for information including a variable keyword in parallel based on a prompt 520 that is provided in various ways among the source information collected in the source database 12 by utilizing the generative artificial intelligence model 510.

The information provision device 100 evaluates the importance based on a similarity between an embedding vector that vectorizes the prompt 520 and an embedding vector of the vector database 13.

The information provision device 100 may finally select the information with the highest importance, and store the selected result information in the result database 14.

According to one embodiment of the present disclosure, the user's intention may be clearly identified through a chain structure with a large language model (LLM), thereby improving the reliability and validity of information.

FIG. 6 is a drawing illustrating the operation of an information provision device according to one embodiment of the present disclosure.

The information provision device 100 may match the collection request items stored in the user database 11, the user information and the result information stored in the result database 14 and transmit the result information to the user terminal 200.

In this case, the information provision device 100 may transmit notification information together with the result information, when the transmitted result information includes a caution keyword.

1. An information provision system that is a generative artificial intelligence-based information provision system, comprising:
a user database configured to store a collection request item for each user;
a source database configured to store source information collected based on the collection request item; and
an information provision device configured to:
search source information comprising a variable keyword among source information collected in the source database based on a pre-provided prompt,
input the prompt and the searched source information to a generative artificial intelligence model to acquire result information corresponding to the prompt, and
transmit result information corresponding to the collection request item to a user terminal.

2. The information provision system of claim 1, wherein the information provision device transmits alarm information together when the result information comprises a caution keyword.

3. The information provision system of claim 1, wherein the information provision device receives the collection request item comprising at least one of a product type, a product manufacturer and a product model name, and stores the collection request item and user information corresponding to the collection request item to construct the user database.

4. The information provision system of claim 1, wherein the information provision device collects the source information based on the collection request item through a web server, stores the source information, and constructs the source database.

5. The information provision system of claim 1, wherein the information provision device constructs a vector database by vector-embedding the source information.

6. The information provision system of claim 5, wherein the information provision device generates the result information based on a similarity between an embedding vector of the prompt and an embedding vector in the vector database by using a generative artificial intelligence model.

7. An information provision device that is a generative artificial intelligence-based information provision device, comprising:
a processor configured to:
search source information comprising a variable keyword among source information collected according to a collection request item for each user based on a pre-provided prompt,
input the prompt and the searched source information to a generative artificial intelligence model to acquire result information corresponding to the prompt, and
transmit result information corresponding to the collection request item to a user terminal.

8. The information provision device of claim 7, wherein the processor transmits alarm information together when the result information comprises a caution keyword.

9. The information provision device of claim 7, wherein the processor receives the collection request item comprising at least one of a product type, a product manufacturer and a product model name, and stores the collection request item and user information corresponding to the collection request item to construct a user database.

10. The information provision device of claim 7, wherein the processor collects the source information based on the collection request item through a web server, stores the source information, and constructs a source database.

11. The information provision device of claim 7, wherein the processor constructs a vector database by vector-embedding the source information.

12. The information provision device of claim 11, wherein the processor generates the result information based on a similarity between an embedding vector of the prompt and an embedding vector in the vector database by using a generative artificial intelligence model.

13. An information provision method that is a generative artificial intelligence-based information provision method performed by an information provision device, the information provision method comprising:
searching source information comprising a variable keyword among source information collected according to a collection request item for each user based on a pre-provided prompt;
inputting the prompt and the searched source information to a generative artificial intelligence model to acquire result information corresponding to the prompt; and
transmitting result information corresponding to the collection request item to a user terminal.
